(19) United States
(12) Patent Application Publication
(10) Pub. No.: US 2003/0102285 A1
(43) Pub. Date: Jun. 5, 2003

(54) Resist pattern thickening material, resist pattern and forming method thereof, and semiconductor device and manufacturing method thereof

(76) Inventors: Koji Nozaki, Kawasaki (JP); Miwa Kozawa, Kawasaki (JP); Takahisa Namiki, Kawasaki (JP); Junichi Kon, Kawasaki (JP); Ei Yano, Kawasaki (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/103,554

(22) Filed: Mar. 22, 2002

(30) Foreign Application Priority Data
Nov. 27, 2001 (JP) 2001-361505

(51) Int. Cl. C23F 1/00; B44C 1/22; C03C 15/00; C03C 25/68

(52) U.S. Cl. 216/41

(57) ABSTRACT

A resist pattern thickening material comprises a resin, a crosslinking agent and a water-soluble aromatic compound. A resist pattern comprises an upperlayer on an underlayer resist pattern with an etching rate (Å/s) ratio of the underlayer resist pattern to the upper layer under the same condition of 1.1 or more, or comprises an upperlayer containing an aromatic compound on an underlayer resist pattern. A method for forming a resist pattern comprises applying a resist pattern thickening material after forming an underlayer resist pattern, on the surface of the pattern. A semiconductor device comprises a pattern formed by the resist pattern. A method for manufacturing the semiconductor device comprises applying after forming an underlayer resist pattern on an underlying layer, the thickening material to the surface of the pattern to thicken the pattern, and patterning the underlying layer by etching using the pattern as a mask.

### CROSS-REFERENCE TO RELATED APPLICATIONS

This application is based upon and claims priority of Japanese Patent Applications No. Hei-1-361505, filed in Nov. 27, 2001, the contents being incorporated herein by reference.

### BACKGROUND OF THE INVENTION

1. Field of the Invention

The present invention relates to a resist pattern having an upperlayer excellent in etching resistance on an underlayer resist pattern usable of ArF excimer laser in patterning and capable of forming a fine pattern, an efficient forming method for the resist pattern, a resist pattern thickening material suitably useable for the forming of the resist pattern and capable of efficiently thickening the underlayer resist pattern to form a fine pattern, a semiconductor device having a fine pattern by this resist pattern, and an efficient manufacturing method for the semiconductor device.

2. Description of the Related Art

In recent years, it has been actively performed to make a pattern for semiconductor device or the like more fine and fine. According to the development of more fine patterns, the exposure light required for pattern formation has also been changing from light such as visible light, laser, etc. to X-ray and electron ray. From the viewpoint of keeping high mass-productivity, however, it is still strongly needed to continue to use the light as the exposure light for the formation of fine patterns. Therefore, it is desired to develop a method capable of efficiently forming a fine pattern by use of a deep ultraviolet beam of short wavelength, which is light, as the exposure light.

A technique called RELACS is described in Japanese Patent Application Laid Open No. 10-73927, in which a fine pattern can be formed by use of KrF (krypton fluoride) excimer laser (wavelength: 248 nm) of deep ultraviolet beam as the exposure light for a photoresist (hereinafter referred to as “resist” for short). This technique comprises forming a resist pattern by exposing the resist (positive type or negative type) with the KrF (krypton fluoride) excimer laser (wavelength: 248 nm) as the exposure light, providing a film by use of a water-soluble resin composition so as to cover the resist pattern, making the film interact with the resist pattern in the interface by use of the residual acid in the material of the resist pattern to thicken (hereinafter often referred also to as “swell”) the resist pattern, thereby shortening the distance between resist patterns to form the fine pattern. According to this technique, in case of a hole pattern, for example, a more fine hole pattern can be formed exceeding the exposure limit.

Recently, the practical use of ArF (argon fluoride) excimer laser (wavelength: 193 nm) as the exposure light for the next generation instead of the KrF (krypton fluoride) excimer laser (wavelength: 248 nm) is promoted, but the ArF excimer laser cannot be used as the exposure light in the above technique. Because the resist for KrF excimer laser (hereinafter referred to as “KrF resist”) used as the resist in the above technique is an aromatic resin composition such as polyhydroxy styrene, naphthoquinone diazide or the like, and since the aromatic ring contained in the aromatic resin composition strongly absorbs the ArF excimer laser, the ArF excimer laser cannot penetrate the KrF resist film even if the exposing light is simply changed from the KrF excimer laser to the ArF excimer laser in the above technique. Therefore, when the ArF excimer laser or a light shorter in wavelength than it is to be used as the exposure light in the above technique, the KrF resist cannot be used, and a resist for ArF excimer laser (hereinafter referred to as “ArF resist”) containing no aromatic ring must be used.

However, the use of the ArF resist as the resist in the above technique causes a problem that the thickening of the resist pattern cannot be efficiently performed. Further, since the water-soluble resin composition used for the film in the above technique is insufficient in etching resistance, the ArF resist thickened by the film is too inferior in etching resistance as the whole to precisely transfer the resist pattern by the ArF resist to a working layer.

Under the present conditions, no technique for material, method or the like capable of forming the film on the resist after forming the resist pattern by use of the ArF excimer laser as the exposure light to thicken the resist pattern and also improving the etching resistance has been developed, and the development of such a technique is desired. Further, no technique for material, method or the like suitably used also for the RELACS to thicken the resist pattern by the KrF resist used in the RELACS and also capable of sufficiently improving its etching resistance has been developed either, and the development of such a technique is also desired.

### SUMMARY OF THE INVENTION

The present invention has an object to provide a resist pattern thickening material suitably usable for the forming of a fine pattern by resist pattern to efficiently thicken an underlayer resist pattern and also capable of imparting etching resistance to the surface thereof.

The present invention has a further object to provide a resist pattern having an upperlayer excellent in etching resistance on an underlayer resist pattern usable of not only KrF excimer laser but also ArF excimer laser in patterning, and capable of forming a fine pattern.

The present invention has another object to provide a method for forming a resist pattern capable of using light as exposure light with excellent mass-productivity and finely manufacturing a fine pattern by resist pattern over the exposure limit of light.

The present invention has an additional object to provide a high-performance semiconductor device having a fine pattern by resist pattern.

The present invention has another object to provide a method for manufacturing a semiconductor device capable of using light as exposure light and efficiently mass-producing a semiconductor device having a fine pattern by resist pattern finely formed thereon exceeding the exposure limit of light.

The resist pattern thickening material of the present invention contains a resin, a crosslinking agent and a water-soluble aromatic compound.

When this resist pattern thickening material is applied onto a resist pattern, the portion thereof present near the interface with the resist pattern is penetrated into the resist pattern and crosslinked with the material of the resist pattern. Therefore, an upperlayer integrated to the resist pattern is formed on the surface of the resist pattern with the resist pattern as an underlayer. Since the upperlayer is formed of the resist pattern thickening material and contains the water-soluble aromatic compound, the upperlayer in the resist pattern is excellent in etching resistance. Since the resist pattern is thickened by the resist pattern thickening material, the pattern formed by the resist pattern has a fine structure.

A resist pattern according to one embodiment of the present invention comprises an upperlayer on an underlayer resist pattern, with a ratio (underlayer resist pattern/upperlayer) in etching rate (Å/s) of the upperlayer to the underlayer resist pattern under the same condition of 1.1 or more.

Since this resist pattern has the highly etching-resistant upperlayer, it is suitable for etching process and suitable for the formation of a fine pattern.

A resist pattern according to another embodiment of the present invention comprises an upperlayer containing an aromatic compound on an underlayer resist pattern containing no water-soluble aromatic compound.

This resist pattern is suitable for etching processing or the like and suitable for the formation of a fine pattern since the underlayer resist pattern is formable by use of the ArF excimer laser as the exposure light, and the highly etching-resistant upperlayer is provided on the underlayer resist pattern.

The method for forming a resist pattern of the present invention comprises a step for applying a resist pattern thickening material so as to cover a surface of an underlayer resist pattern after formation of the underlayer resist pattern.

In this method, the resist pattern thickening material is applied onto the surface of the underlayer resist pattern after the underlayer resist pattern is formed. Then, the resist pattern thickening material present near the interface with the underlayer resist pattern is penetrated into the resist pattern and crosslinked with the material of the underlayer resist pattern. Therefore, the upperlayer integrated to the underlayer resist pattern is formed on the underlayer resist pattern. Since the upperlayer is formed of the resist pattern thickening material and contains the water-soluble aromatic compound, the upperlayer in the resulting resist pattern is excellent in etching resistance. Since the resulting resist pattern is thickened by the resist pattern thickening material, the pattern formed by the resist pattern has a fine structure.

The semiconductor device of the present invention comprises at least a pattern formed by the above resist pattern.

This semiconductor device has a high quality and high performance since it has a fine pattern formed by this resist pattern.

The method for manufacturing a semiconductor device of the present invention comprises a step for forming a resist pattern by applying a resist pattern thickening material to cover a surface of an underlayer resist pattern to thicken the underlayer resist pattern to form the resist pattern, after forming the underlayer resist pattern on an underlying layer, and a step for patterning the underlying layer by performing an etching using the resist pattern formed in the step for forming the resist pattern as a mask.

In this method for manufacturing a semiconductor device, the resist pattern thickening material is applied onto the underlayer resist pattern after the underlayer resist pattern is formed on the underlying layer. The resist pattern thickening material present near the interface with the underlayer resist pattern is then penetrated into the underlayer resist pattern and crosslinked with the material of the resist pattern. Therefore, an upperlayer integrated with the underlayer resist pattern is formed on the underlayer resist pattern. Since the upperlayer is formed of the resist pattern thickening material and contains the water-soluble aromatic compound, the upperlayer in the resulting resist pattern is excellent in etching resistance, and the etching processing or the like can be suitably performed. Since the resulting resist pattern is thickened by the resist pattern thickening material, the width of the pattern by the resist pattern is smaller than the pattern width by the underlayer resist pattern by the thickened portion by the resist pattern thickening material, and the pattern by the resist pattern is formed finely exceeding the exposure limit of light. Since the underlying layer is patterned by the etching with the pattern as mask, a semiconductor device having an extremely fine pattern can be efficiently manufactured.

### BRIEF DESCRIPTION OF THE DRAWING

FIGS. 1A through 1C is a schematic view for showing the mechanism of thickening of a resist pattern (underlayer resist pattern) by use of a resist pattern thickening material according to the present invention.

FIGS. 2A through 2E are schematic views for showing a method for forming a resist pattern according to the present invention.

FIGS. 3A and 3B are upper surface views of a FLASH EPROM that is one example of a semiconductor device according to the present invention.

FIGS. 4A through 4C are schematic sectional views (1) for showing a manufacturing method for FLASH EPROM that is one example of a method for manufacturing a semiconductor device according to the present invention.

FIG. 5D through F are schematic sectional views (2) for showing a manufacturing method for EPROM that is one example of a method for manufacturing a semiconductor device according to the present invention.

FIG. 6G through I are schematic sectional views (3) for showing a manufacturing method for EPROM that is one example of a method for manufacturing a semiconductor device according to the present invention.

FIG. 7A through C are schematic sectional views for showing a manufacturing method for EPROM that is another embodiment of the method for manufacturing a semiconductor device according to the present invention.

FIG. 8A through C are schematic sectional views for showing a manufacturing method for EPROM that is another embodiment of the method for manufacturing a semiconductor device according to the present invention.

FIGS. 9A through 9D are schematic sectional views for showing one example of the application of a resist pattern thickened by use of the resist pattern thickening material of the present invention to manufacture of a magnetic head.

FIG. 10 is a schematic sectional view for showing a process (1) of another example of the application of the resist pattern thickened by use of the resist pattern thickening material of the present invention to manufacture of a magnetic head.

FIG. 11 is a schematic sectional view for showing a process (2) of another example of the application of the resist pattern thickened by use of the resist pattern thickening material of the present invention to manufacture of a magnetic head.

FIG. 12 is a schematic sectional view for showing a process (3) of another example of the application of the resist pattern thickened by use of the resist pattern thickening material of the present invention to manufacture of a magnetic head.

FIG. 13 is a schematic sectional view for showing a process (4) of another example of the application of the resist pattern thickened by use of the resist pattern thickening material of the present invention to manufacture of a magnetic head.

FIG. 14 is a schematic sectional view for showing a process (5) of another example of the application of the resist pattern thickened by use of the resist pattern thickening material of the present invention to manufacture of a magnetic head.

FIG. 15 is a schematic sectional view for showing a process (6) of another example of the application of the resist pattern thickened by use of the resist pattern thickening material of the present invention to manufacture of a magnetic head.

FIG. 16 is a plan view showing one example of the magnetic head manufactured in the processes of FIGS. 10-15.

### DESCRIPTION OF THE PREFERRED EMBODIMENTS

The present invention is based on the following knowledge by the present inventors. Namely, the thickening of the resist pattern cannot be efficiently performed to ArF resists. The affinity of the resist pattern with the film formed on the surface thereof is remarkably different between the formation by use of ArF resists and the formation by use of KrF resists, and the affinity is remarkably inferior in the formation of the resist pattern formed by use of ArF resists. Therefore, the resist pattern can be efficiently thickened by improving the composition of the film so as to enhance the affinity with the resist pattern by the ArF resist, and the etching resistance of the resist pattern surface can be remarkably improved by using the water-soluble aromatic compound.

(Resist Pattern Thickening Material)

The resist pattern thickening material of the present invention is a water-soluble composition, which contains a resin, a crosslinking agent, and a water-soluble aromatic compound and further contains a nonionic surfactant, an organic solvent, and other components as occasion demands.

This resist pattern thickening material may be in any of aqueous form, colloidal form, emulsion-like form and the like, but is preferably in the aqueous form.

Resin

The resin is not particularly limited, and any one can be properly selected according to purposes. A cross-linkable one or a one not cross-linkable but mixable with a water-soluble crosslinking agent is preferable, including polyvinyl alcohol, polyvinyl acetal, polyvinyl acetate, polyacrylic acid, polyvinyl pyrolidone, polyethylene imine, polyethylene oxide, styrene-maleic acid copolymer, polyvinyl amine, polyarylamine, oxazoline group-containing water-soluble resin, water-soluble melamine resin, water-soluble urea resin, alkyd resin, sulfonamide resin, etc.

These may be used individually or in combination. Of these, the polyvinyl alcohol, polyvinyl acetal and polyvinyl acetate are preferably used. In the present invention, the resin preferably contains the polyvinyl acetal, and more preferably contains 5-40% by mass (by mol) of the polyvinyl acetal because the solubility is easily changeable by crosslinking.

The content of the resin in the resist pattern thickening material may be properly determined although it is varied depending on the kind, content and the like of the above crosslinking agent, water-soluble aromatic compound and the like and cannot be regulated indiscriminately.

Crosslinking Agent

The crosslinking agent is not particularly limited, and any one can be properly selected according to purposes. A water-soluble one which is cross-linkable by heat or acid is preferable, suitably including an amino type crosslinking agent and the like.

Suitable examples of the amino type crosslinking agent include a melamine derivative, a urea derivative, a uril derivative and the like. These may be used individually or in combination.

Examples of the urea derivative include urea, alkoxy methylene urea, N-alkoxy methylene urea, ethylene urea, ethylene urea carboxylic acid, derivatives thereof, etc.

Examples of the melamine derivative include alkoxymethyl melamine, derivatives thereof, etc.

Examples of the uril derivative include benzoguanamine, glycouril, derivatives thereof, etc.

The content of the crosslinking agent in the resist pattern thickening material may be properly determined according to purposes although it is varied depending on the kind, content and the like of the above resin, water-soluble aromatic compound and the like and cannot be indiscriminately regulated.

Water-Soluble Aromatic Compound

The water-soluble aromatic compound is not particularly limited, and any aromatic compound which is water-soluble can be properly selected according to purposes. Particularly, it preferably shows water solubility of 1 g or more to 100 g of 25° C. water, more preferably 3 g or more to 100 g of 25° C. water, and particularly preferably 5 g or more to 100 g of 25° C. water.

Examples of the water-soluble aromatic compound include a polyphenol compound, an aromatic carboxylic acid compound, a perhydroxy naphthalene compound, a benzophenone compound, a flavonoid compound, a porphine, a water-soluble phenoxy resin, an aromatic-containing water-soluble pigment, derivatives and glycosides thereof, and the like. These may be used individually or in combination.

Examples of the polyphenol compound and derivatives thereof include catechin, anthocyanidin (pelargonidine type (4′-hydroxy), cyanidin type (3′,4′-dihydroxy), delphinidin type (3′, 4′, 5′-trihydroxy), flavane-3,4-diol, proantocyanidin, resolcinol, resolcinol[4]arene, pyrogallol, gallic acid, derivatives and glycosides thereof, etc.

Examples of the aromatic carboxylic acid compound and derivatives thereof include salicylic acid, phthalic acid, dihydroxybenzoic acid, tannin, derivatives and glycosides thereof, etc.

Examples of the perhydroxy naphthalene compound and derivatives thereof include naphthalene diol, naphthalene triol, derivatives and glycosides thereof, etc.

Examples of the benzophenone compound and derivative thereof include alizarin yellow A, derivatives and glycosides thereof, etc.

Examples of the flavonoid compound and derivatives thereof include flavone, isoflavone, flavanol, flavonone, flavonol, flavan-3-ol, aurone, chalcone, dihydrochalcone, quercetin, derivatives or glycosides thereof, etc.

Such a water-soluble aromatic compound preferably has at least two polar groups from the point of excellent water-solubility, more preferably three or more groups, and particularly preferably four or more groups.

The polar group is not particularly limited, and any polar group can be properly selected according to purposes, including hydroxyl group, carboxyl group, carbonyl group, sulfonyl group and the like.

The content of the water-soluble aromatic compound in the resist pattern thickening material may be properly determined according to purposes although it is varied depending on the kind, content and the like of the above resin, crosslinking agent and the like and cannot be indiscriminately regulated.

Surfactant

The surfactant can be suitably used when the affinity of the resist pattern thickening material with the resist pattern (underlayer resist pattern) to be applied to the resist pattern thickening material is insufficient. When the surfactant is included in the resist pattern thickening material, the resist pattern (underlayer resist pattern) can be efficiently thickened in the state excellent in in-plane uniformity to form a fine pattern, and the foaming of the resist pattern thickening material can be also effectively suppressed.

The surfactant is not particularly limited, and any one can be properly selected according to purposes, including a nonionic surfactant, a cationic surfactant, an anionic surfactant, an ampholytic surfactant, a silicone type surfactant and the like. Of these, the nonionic surfactant is preferable because it has a structure containing no metal ion. These may be used individually or in combination.

Concrete examples of the surfactant include a polyoxyethylene-polyoxypropylene condensed type, a polyoxyalkylene alkyl ether type, a polyoxyethylene alkyl ether type, a polyoxyethylene derivative type, a sorbitan fatty acid ester type, a glycerin fatty acid ester type, a primary alcohol ethoxylate type, a phenol ethoxylate type, and the like.

The content of the surfactant in the resist pattern thickening material may be properly determined according to purposes although it is varied depending on the kind, content and the like of the above resin, crosslinking agent, water-soluble aromatic compound and the like and cannot be indiscriminately regulated.

Organic Solvent

The organic solvent can improve the solubility of the above resin, crosslinking agent, and water-soluble aromatic compound in the resist pattern thickening material by being included in the resist pattern thickening material.

The organic solvent is not particularly limited, and any one can be properly selected according to purposes, including an alcoholic organic solvent, a chain ester organic solvent, a cyclic ester organic solvent, a ketone organic solvent, a chain ether organic solvent, a cyclic ether organic solvent and the like.

Examples of the alcoholic organic solvent include methanol, ethanol, propyl alcohol, isopropyl alcohol, butyl alcohol, etc.

Examples of the chain ester organic solvent include ethyl lactate, propylene glycol methyl ether acetate (PGMEA), etc.

Examples of the cyclic ester organic solvent include a lactone type such as γ-butyrolactone, etc.

Examples of the ketone organic solvent include a ketone type such as acetone, cyclohexanone, heptanone, etc.

Examples of the chain ether organic solvent include ethylene glycol dimethyl ether, etc.

Examples of the cyclic ether include tetrahydrofuran, dioxane, etc.

These organic solvents may be used individually or in combination. Of these, a one having a boiling point of about 80-200° C. is preferably used because the thickening can be finely performed.

The content of the organic solvent in the resist pattern thickening material may be properly determined according to purposes although it is varied depending on the kind, content and the like of the above resin, crosslinking agent, water-soluble aromatic compound, and surfactant and cannot be indiscriminately regulated.

Other Components

Other components are not particularly limited as long as they do not impair the effect of the present invention, and any one can be properly selected according to purposes, including known additives of all sorts, e.g., a thermal acid generator, a quencher represented by amine type, amide type, ammonium salt, etc., and the like.

The content of the other components in the resist pattern thickening material may be properly determined according to purposes although it is varied depending on the kind, content and the like of the above resin, crosslinking agent, water-soluble aromatic compound, surfactant, organic solvent and the like and cannot be indiscriminately regulated.

Use or the Like

The resist pattern thickening material of the present invention can be used by applying onto the resist pattern (underlayer resist pattern).

In the application, the surfactant may be separately applied prior to the application of the resist pattern thickening material without being included in the resist pattern thickening material.

When the resist pattern thickening material is applied onto the resist pattern (underlayer resist pattern) and crosslinked therewith, the resist pattern (underlayer resist pattern) is thickened to form an upperlayer excellent in etching resistance on the resist pattern (underlayer resist pattern). Consequently, the width of the pattern formed by the resist pattern (underlayer resist pattern) is further narrowed to form a fine pattern.

Material for Resist Pattern (Underlayer Resist Pattern)

The material for the resist pattern (underlayer resist pattern) is not particularly limited, and any one can be properly selected from known resist materials according to purposes, which may be of negative type and positive type, including a chemically amplified resist material represented by the KrF resist and the ArF resist.

The ArF resist is not particularly limited, and any one can be properly selected according to purposes, suitably including an alicyclic resist.

Examples of the alicyclic resist include an acrylate resist having an alicyclic functional group in the side chain, a cycloolefin-maleic anhydride (COMA type) resist, a cycloolefin resist, a hybrid (alicyclic acrylate-COMA copolymer) resist, etc.

The alicyclic functional group is not particularly limited, and any one can be properly selected according to purposes, suitably including an adamantly group, a norbornane group, and the like. The cycloolefin resists suitably include a one containing adamantane, norbornane, tricyclononene or the like in the main chain.

The forming method, size, thickness and the like of the resist pattern (underlayer resist pattern) are not particularly limited, and any one can be properly selected according to purposes. Particularly, the thickness is generally set to about 0.3-0.7 μm although it can be properly determined depending on the underlying layer to be worked, etching conditions and the like.

The thickening of the resist pattern (underlayer resist pattern) using the resist pattern thickening material of the present invention is described below in reference to the drawings.

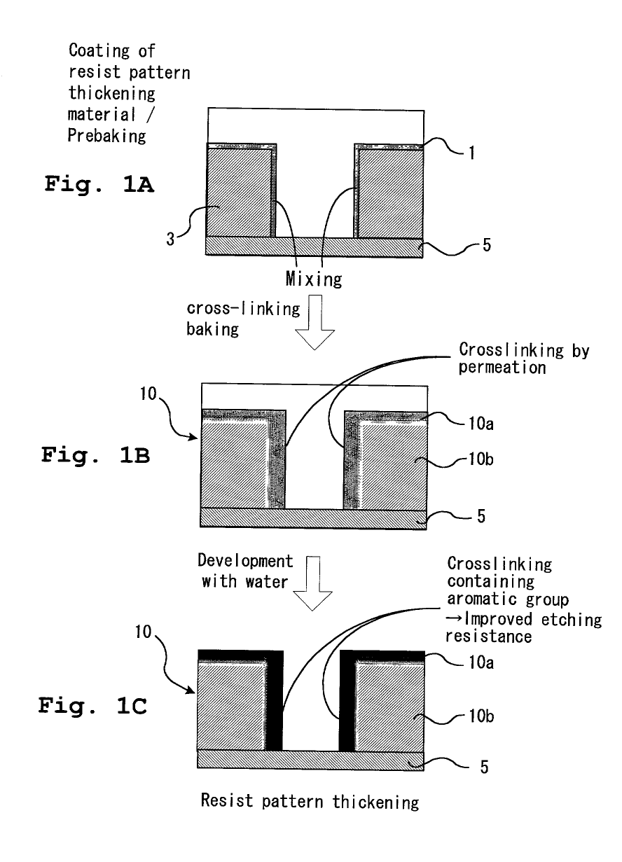

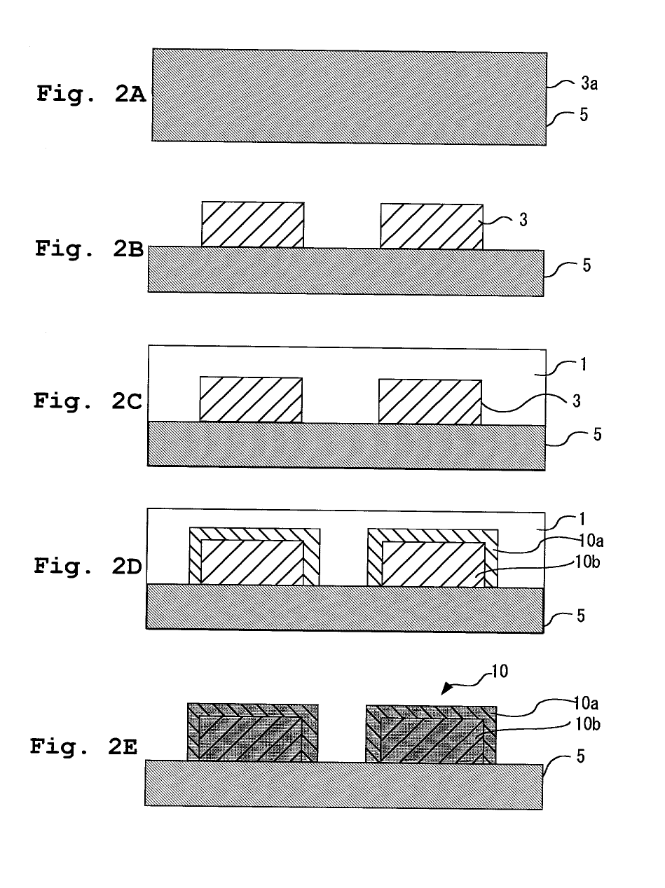

As shown in FIG. 1A, a resist pattern (underlayer resist pattern) 3 is formed on a substrate (base material) 5, and a resist pattern thickening material 1 is then applied to the surface of the resist pattern (underlayer resist pattern) 3 and pre-baked (heated and dried) to form a film. The mixing (penetration) of the resist pattern thickening material 1 into the resist pattern (underlayer resist pattern) 3 then occurs in the interface between the resist pattern (underlayer resist pattern) 3 and the resist pattern thickening material 1.

When a crosslinking baking (crosslinking reaction) is performed at a temperature higher than in the pre-baking (heating and drying) as shown in FIG. 1B, the mixed (penetrated) part is crosslinked in the interface between the resist pattern (underlayer resist pattern) 3 and the resist pattern thickening material 1.

Thereafter, a developing processing is performed as shown in FIG. 1C, whereby the part non crosslinked with the resist pattern (underlayer resist pattern) 3 and the weakly crosslinked part (highly water-soluble part) of the applied resist pattern thickening material 1 are dissolved and removed to form (develop) a thickened resist pattern 10.

The step for developing may be water development or a development with weak alkali aqueous solution. The water development is preferable because the step for developing can be efficiently performed at a low cost.

The resist pattern 10 comprises an upperlayer 10a formed by crosslinking the resist pattern thickening material 1 onto the resist pattern (underlayer resist pattern) 3 on the surface of an underlayer resist pattern 10b. Since the resist pattern 10 is thickened by the thickness portion of the upperlayer 10a, compared with the resist pattern (underlayer resist pattern) 3, the width of the pattern formed by the resist pattern 10 is smaller than that of the pattern formed by the resist pattern (underlayer resist pattern) 3, and the pattern formed by the resist pattern 10 is fine.

The upperlayer 10a in the resist pattern 10 is formed of the resist pattern thickening material 1, and the resist pattern thickening material 1 is remarkably excellent in etching resistance because it contains the water-soluble aromatic compound. Therefore, even if the resist pattern (underlayer resist pattern) 3 is formed of a material inferior in etching resistance, the resist pattern 10 having the upperlayer 10a excellent in etching resistance on the surface is thus remarkably excellent in etching resistance.

Use

The resist pattern thickening material of the present invention can be suitably used for a structure by resin or the like to be exposed to plasma, which requires the improvement in etching resistance of the surface, more suitably used when an aromatic compound cannot be used as the material of the structure, further suitably used for the thickening of the resist pattern, and particularly suitably used for the resist pattern and forming method thereof of the present invention and the semiconductor device and manufacturing method thereof of the present invention.

(Resist Pattern)

The resist pattern of the present invention comprises an upperlayer on an underlayer resist pattern.

The upperlayer is preferably excellent in etching resistance, and its etching rate (Å/s) is preferably small, compared with the underlayer resist pattern. Concretely, the ratio (underlayer resist pattern/upperlayer) in etching rate (Å/s) of the underlayer resist pattern to the upperlayer is preferably 1.1 or more, more preferably 1.2 or more, and particularly preferably 1.3 or more.

The etching rate (Å/s) can be measured, for example, by performing an etching processing for a prescribed time by use of a known etching device to measure the film reducing amount of a sample and calculating the film reducing amount per unit time.

The upperlayer preferably contains an aromatic compound and can be suitably formed by use of the resist pattern thickening material of the present invention.

Whether the upperlayer contains the aromatic compound or not can be confirmed, for example, by analyzing the IR or UV absorption spectrum for this upperlayer.

The resist pattern of the present invention may have a structure having a clear boundary between the underlayer resist pattern and the upperlayer or an unclear boundary. In the former structure, the content of the aromatic compound is generally discontinuously reduced from the upperlayer to the inner part, and in the latter structure, the content of the aromatic compound is generally gradually reduced from the upperlayer to the inner part.

The resist pattern of the present invention can be suitably manufactured according to the method for forming the resist pattern of the present invention described below.

The resist pattern of the present invention can be suitably used for a functional part such as mask pattern, rectile pattern, magnetic head, LCD (liquid crystal display), PDP (plasma display panel), SAW filter (surface acoustic wave filter), etc.; an optical part used for connection of wiring by light; a micro part such as micro actuator, etc.; a semiconductor device and the like, and suitably used for the semiconductor device of the present invention described later.

(Method for Forming a Resist Pattern)

The method for forming the resist pattern of the present invention comprises a step for applying a resist pattern thickening material so as to cover a surface of an underlayer resist pattern after formation of the underlayer resist pattern

The materials for the underlayer resist pattern include those described above for the resist pattern thickening material of the present invention.

The underlayer resist pattern can be formed according to a known method.

The underlayer resist pattern can be formed of an underlying layer (base material). The underlying layer (base material) is not particularly limited, and any one can be properly selected according to purposes. When the underlayer resist pattern is formed on a semiconductor device, the substrate is such as silicon or the like.

The application method for the resist pattern thickening material is not particularly limited, and any method can be properly selected from known application methods according to purposes, suitably including spin coating and the like. The condition for the spin coating, for example, the cycle is set to about 100-10000 rpm, preferably 800-5000 rpm, and the time is set to about 1 sec-10 min, preferably 1-60 sec.

In the application, the surfactant may be separately applied prior to the application of the resist pattern thickening material without being included in the resist pattern thickening material.

The applied resist pattern thickening material is preferably pre-baked (heated and dried) in or after the application because the mixing (penetration) of the resist pattern thickening material into the underlayer resist pattern can be efficiently caused in the interface between the underlayer resist pattern and the resist pattern thickening material.

The condition, method and the like of the pre-baking (heating and drying) are not particularly limited, and any one can be properly selected according to purposes. For example, the temperature is set to about 40-120° C., preferably 70-100° C., and the time is set to about 10 sec-5 min, preferably 40-100 sec.

The crosslinking baking (crosslinking reaction) of the applied resist pattern thickening material is preferably performed after the pre-baking (heating and drying) because the crosslinking reaction of the mixed (penetrated) part can be efficiently progressed in the interface between the underlayer resist pattern and the resist pattern thickening material.

The condition, method and the like of the crosslinking baking (crosslinking reaction) are not particularly limited, and any one can be properly selected according to purposes. Generally, a temperature condition higher than the pre-baking (heating and drying) is adapted. For the condition of the crosslinking baking (crosslinking reaction), for example, the temperature is set to about 70-150° C., preferably 90-130° C., and the time is set to about 10 sec-5 min, preferably 40-100 sec.

The step for developing the applied resist pattern thickening material is preferably performed after the crosslinking baking (crosslinking reaction) because the part not crosslinked with the underlayer resist pattern and the part weakly crosslinked therewith (highly water-soluble part) of the applied resist pattern thickening material can be dissolved and removed to develop the resist pattern of the present invention manufactured in the thickened state.

The step for developing is the same as described above.

The method for forming the resist pattern of the present invention is then described below in reference to the drawings.

A resist material 3a is applied onto a substrate (base material) 5 as shown in FIG. 2A and then patterned as shown in FIG. 2B to form a resist pattern (underlayer resist pattern) 3. A resist pattern thickening material 1 is applied onto the surface of the resist pattern (underlayer resist pattern) 3, and pre-baked heated and dried) to form a paint film. The mixing (penetration) of the resist pattern thickening material 1 into the resist pattern (underlayer resist pattern) 3 occurs in the interface between the resist pattern (underlayer resist pattern) 3 and the resist pattern thickening material 1.

When a crosslinking baking (crosslinking reaction) is preformed at a temperature higher than in the pre-baking (heating and drying) as shown in FIG. 2D, the mixed (penetrated) part is crosslinked in the interface between the resist pattern (underlayer resist pattern) 3 and the resist pattern thickening material 1. Thereafter, a step for developing is performed as shown in FIG. 2E, whereby the part not crosslinked with the resist pattern (underlayer resist pattern) 3 and the part weakly crosslinked therewith (highly water-soluble part) of the applied resist pattern thickening material 1 is dissolved and removed to form (develop) a resist pattern 10 having an upperlayer 10a on an underlayer resist pattern 10b.

The step for developing may be water development or a development with weak alkali aqueous solution. The water development is preferable because the step for developing can be efficiently performed at a low cost.

The resist pattern 10 comprises the upperlayer 10a formed by crosslinking the resist pattern thickening material 1 onto the resist pattern (underlayer resist pattern) 3 on the surface of the underlayer resist pattern 10b. Since the resist pattern 10 is thickened by the thickness portion of the upperlayer 10a, compared with the resist pattern (underlayer resist pattern) 3, the width of the pattern formed by the resist pattern 10 is smaller than that of the pattern formed by the resist pattern (underlayer resist pattern) 3, and the pattern formed by the resist pattern 10 is fine.

The upperlayer 10a in the resist pattern 10 is formed of the resist pattern thickening material 1, and the resist pattern thickening material 1 is excellent in etching resistance since it is contains the water-soluble aromatic compound. Therefore, even if the resist pattern (underlayer resist pattern) 3 is formed of a material inferior in etching material, the resist pattern 10 having the upperlayer 10a excellent in etching resistance on the surface is thus remarkably excellent in etching resistance.

The resist pattern formed according to the method for forming the resist pattern of the present invention is the resist pattern of the present invention. This resist pattern comprises the upperlayer formed by crosslinking the resist pattern thickening material of the present invention onto the underlayer resist pattern on the surface of the underlayer resist pattern, and the upperlayer is remarkably excellent in etching resistance because it contains the water-soluble aromatic compound. Therefore, even if the underlayer resist pattern is formed of a material inferior in etching resistance, the resist pattern having the upperlayer excellent in etching resistance on the surface of the underlayer resist pattern can be efficiently formed according to the forming method for resist pattern of the present invention. The resist pattern formed according to the forming method for resist pattern of the present invention is thickened by the thickness portion of the upperlayer, compared with the underlayer resist pattern, the width of the pattern formed by the manufactured resist pattern is smaller than that of the pattern formed by the underlayer resist pattern. According to the forming method for resist pattern of the present invention, a fine pattern can be thus efficiently manufactured.

The resist pattern formed according to the forming method for resist pattern of the present invention can be suitably used for a functional part such as mask pattern, rectile pattern, magnetic head, LCD (liquid crystal display), PDP (plasma display panel), SAW filter (surface acoustic wave filter), etc.; an optical part used for connection of wiring by light; a micro part such as micro actuator, etc.; a semiconductor device; and the like, and also suitably used for the semiconductor device of the present invention described below.

(Semiconductor Device and Method for Manufacturing a Semiconductor Device)

The semiconductor device of the present invention is not particularly limited except having the above-described resist pattern of the present invention, and comprises known members properly selected according to purposes.

Concrete examples of the semiconductor device of the present invention suitably include flash memory, DRAM, FRAM and the like.

The semiconductor device of the present invention can be suitably manufactured according the method for manufacturing a semiconductor device of the present invention described below.

The method for manufacturing a semiconductor device of the present invention comprises a step for forming a resist pattern and a step for patterning, and further comprises other processes properly selected as occasion demands.

The step for forming a resist pattern comprises a step for forming a resist pattern by applying a resist pattern thickening material to cover a surface of an underlayer resist pattern to thicken the underlayer resist pattern to form the resist pattern, after forming the underlayer resist pattern on an underlying layer. The underlying layers include surface layers for all kinds of members in semiconductor devices, and a substrate such as silicon wafer and surface layer thereof are suitably used. The underlayer resist pattern is the same as described above. The application method is also the same as described above. After the application, the above-mentioned pre-baking, crosslinking baking and the like are preferably performed.

The step for patterning comprises patterning the underlying layer by performing an etching using the resist pattern formed in the step for forming the resist pattern as a mask.

The etching method is not particularly limited, and any method can be properly selected from known methods according to purposes, suitably including dry etching and the like. The condition of the etching is not particularly limited, and any one can be properly selected according to purposes.

Suitable examples of the other processes include a step for applying surfactant, a step for developing and the like.

The step for applying surfactant comprises applying the surfactant to the surface of the underlayer resist pattern prior to the step for forming a resist pattern.

The surfactant is the same as described above, and it is preferably a nonionic surfactant, more preferably at least one type selected from a polyoxyethylene-polyoxypropylene condensed compound, a polyoxyalkylene alkyl ether compound, a polyoxyethylene alkyl ether compound, a polyoxyethylene derivative compound, a sorbitan fatty acid ester compound, a glycerin fatty acid ester compound, a primary alcohol ethoxylate compound, and a phenol ethoxylate compound.

The step for developing comprises performing the step for developing of the applied resist pattern thickening material prior to the step for patterning after the step for forming a resist pattern. The step for developing is the same as described above.

According to the method for manufacturing a semiconductor device of the present invention, for example, semiconductor devices of all sorts including flash memory, DRAM, FRAM and the like can be efficiently manufactured.

### EXAMPLE

Preferred embodiments of the present invention are more concretely described below, but the present invention is never limited by these embodiments.

### Example 1

Preparation of Resist Pattern Thickening Material

Resist pattern thickening materials A-I according to the present invention having compositions shown in Table 1 were prepared. In Table 1, the unit of the numeric in parentheses represents a part by mass. In the column of “Resin”, “KW3” represents a polyvinyl acetal resin (manufactured by SEKISUI CHEMICAL), and “PVA” shows a polyvinyl alcohol resin (manufactured by KURARAY, Poval 117). In the column of “Crosslinking agent”, “Uril” represents tetramethoxymethyl glycouril, “Urea” represents N, N′-dimethoxymethyl dimethoxyethyleneurea, and “Melamine” represents hexamethoxymethylmelamine. In the column of “Surfactant”, “TN-80” represents a nonionic surfactant (manufactured by ASAHI DENKA, polyoxyethylene monoalkyl ether surfactant). As the main solvent component except the above resin, crosslinking agent, and water-soluble aromatic compound, a mixture of pure water (deionized water) and isopropyl alcohol (mass ratio of pure water (deionized water) to isopropyl alcohol=82.6:0.4) was used.

TABLE 1

| | | | Water-soluble | |
|---|---|---|---|---|
| | | Crosslinking | aromatic | |
| | Resin | agent | compound | Surfactant |
| A | KW-3 | Uril (1.16) | Catechin (5) | None |
| | (16) | | | |
| B | KW-3 | Urea (1.16) | Catechin (5) | None |
| | (16) | | | |
| C | KW-3 | Melamine | Catechin (5) | None |
| | (16) | (0.8) | | |
| | PVA(3) | | | |
| D | KW-3 | Uril (1.16) | Catechin (5) | TN-80 (0.25) |
| | (16) | | | |
| E | KW-3 | Urea (1.16) | Catechin (5) | PC-8 (0.25) |
| | (16) | | | |
| F | KW-3 | Melamine | Catechin (5) | PC-12 (0.25) |
| | (16) | (0.8) | | |
| G | KW-3 | Uril (1.16) | Delphinidin (5) | None |
| | (16) | | | |
| H | KW-3 | Uril (1.16) | Resorcinol (5) | TN-80 (0.25) |
| | (16) | | | |
| I | KW-3 | Urea (1.16) | 1,3-Naphthalene | PC-8 (0.25) |
| | (16) | | | |

Resist Pattern and Manufacture Thereof

Each of the thus-prepared resist pattern thickening materials A-I was applied to a hole pattern formed by the ArF resist (manufactured by SUMITOMO CHEMICAL, PAR700) by spin coating first in a condition of 1000 rpm/5 s and then in a condition of 3500 rpm/40 s, and subjected to pre-baking in a condition of 85° C./70 s and further to crosslinking baking in a condition of 110° C./70 s. The resulting resist pattern thickening materials A-I were then rinsed with pure water (deionized water) for 60 sec to remove the non-crosslinked part, and the resist patterns thickened by the resist pattern thickening materials A-I were developed, whereby the respective resist patterns were manufactured.

The sizes of the patterns formed by the manufactured resist patterns (thickened resist patterns) were shown in Table 2 together with the sizes of the patterns formed by initial pattern sizes (the sizes of the hole patterns before thickening). In Table 2, “A”-“I” correspond to the resist pattern thickening materials A-I, respectively.

TABLE 2

| | Initial pattern | Pattern size after |
|---|---|---|
| | size (nm) | thickening (nm) |
| A | 200.5 | 175.2 |
| B | 203.3 | 181.2 |
| C | 199.8 | 180.0 |
| D | 205.7 | 154.4 |
| E | 202.6 | 171.7 |
| F | 203.9 | 160.3 |
| G | 198.8 | 171.7 |
| H | 201.1 | 148.7 |
| I | 200.8 | 165.6 |

Each of the thus-prepared resist pattern thickening materials A-I was applied to a line & space pattern formed by the ArF resist (manufactured by SUMITOMO CHEMICAL, PAR700) by spin coating first in a condition of 1000 rpm/5 s and then in a condition of 3500 rpm/40 s, and subjected to pre-baking in a condition of 85° C./70 s and further to crosslinking baking in a condition of 110° C./70 s. The resulting resist pattern thickening materials A-I were then rinsed with pure water (deionized water) for 60 sec to remove the non-crosslinked part, and the resist patterns thickened by the resist pattern thickening materials A-I were developed, whereby the respective resist patterns were manufactured.

The sizes of the patterns formed by the manufactured resist patterns (thickened resist patterns) were shown in Table 3 together with the sizes of the patterns formed by initial pattern sizes (the sizes of the line & space pattern before thickening). In Table 3, “A”-“I” correspond to the resist pattern thickening materials A-I, respectively.

TABLE 3

| | Initial pattern space | Pattern space size after |
|---|---|---|
| | size (nm) | thickening (nm) |
| A | 165.2 | 135.2 |
| B | 162.3 | 143.8 |
| C | 159.8 | 137.7 |
| D | 155.7 | 116.9 |
| E | 158.5 | 128.8 |
| F | 160.2 | 123.0 |
| G | 163.4 | 125.4 |
| H | 160.0 | 121.1 |
| I | 158.0 | 120.5 |

It is apparent from the results of Tables 2 and 3 that the resist pattern thickening material of the present invention is applicable to both a hole pattern and a line & space pattern to thicken them. The resist pattern thickening material of the present invention can make the inside diameter of the hole pattern narrow and fine when used for the formation of the hole pattern, make the width of a linear pattern (the space between resist patterns forming the linear pattern) small and fine when used for the formation of the linear pattern, and increase the area of an isolated pattern when used for the formation of the isolated pattern.

The resist pattern thickening materials D, H and I of the present invention were applied and crosslinked onto the surface of a resist formed on a silicon substrate to form upperlayers 0.5 μm thick thereon, respectively. These upperlayers and the KrF resist (manufactured by SHIPLEY, UV-6) and a polymethyl methacrylate (PMMA) for comparison were etched for 3 fines by use of an etching machine (Parallel-plate type RIE device, manufactured by FUJITSU) under conditions of P μ=200W, pressure=0.02 Torr, CF₄ gas=100 sccm, and the film reduction amounts of samples were measured to calculate the etching rates, which were then relatively evaluated on the basis of the etching rate of the KrF resist.

TABLE 4

| Material | Etching rate | Rate |
|---|---|---|
| name | (Å/s) | ratio |
| UV-6 | 627 | 1.00 |
| PMMA | 770 | 1.23 |
| D | 600 | 0.96 |
| H | 610 | 0.97 |
| I | 590 | 0.94 |

It is apparent from the result of Table 4 that the etching resistances of the resist pattern thickening materials of the present invention are close to the KrF resist and more remarkably excellent than the PMMA.

When the resist pattern thickening materials A-I were applied onto the underlayer resist pattern on a wafer substrate allowed to stand out of a clean room for 1 month after exposure, the same pattern thickening effect as in the immediate application after exposure can be obtained.

It is supposed from this result that the resist pattern thickening material of the present invention thickens the underlayer resist pattern not by use of a crosslinking reaction by diffusion of acid as the conventional technique called RELACS, but depending on the compatibility with the underlayer resist pattern.

### Example 2

Flash Memory and Its Manufacture

Example 2 is one embodiment of the semiconductor device and manufacturing method thereof of the present invention using the resist pattern thickening material of the present invention. In Example 2, resist films 26, 27, 29, 32 and 34 are thickened by use of the resist pattern thickening material of the present invention according to the same method as in Example 1.

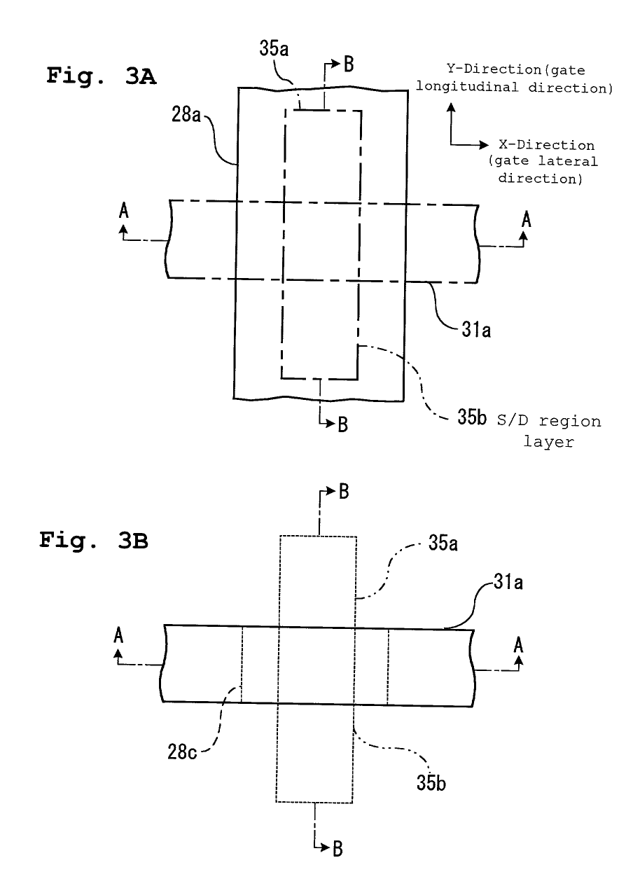

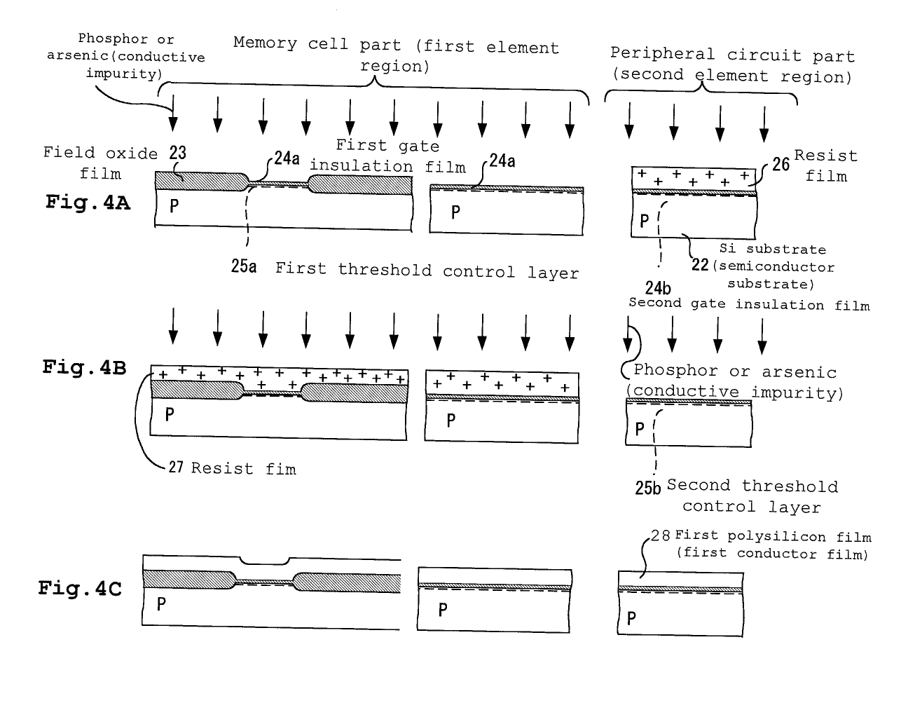

FIGS. 3A and B are upper surface views (plan views) of a FLASH EPROM called FLOTOX type or ETOX type. FIGS. 4A to 4C, FIGS. 5D to 5F, and FIGS. 6G to 61 are schematic sectional views for showing one example for the manufacturing method for the FLASH EPROM, wherein the left views in FIGS. 4A through 61 are schematic sectional (A-directional sectional) views in the gate lateral direction (X-direction in FIG. 3A) of the part for forming a MOS transistor having a floating gate electrode in a memory cell pat (first element region), the central views are schematic sectional (B-directional sectional) views in the gate longitudinal direction (Y-direction in FIG. 3A) orthogonal to the X-direction in the memory cell part of the same part as in the left views, and the right views are schematic sectional (A-directional sectional in FIG. 3A and B) views of the part for forming a MOS transistor in a peripheral circuit part (second element region).

A field oxide film 23 by SiO₂ film was selectively formed on the element separating region on a p-type Si substrate 22 as shown in FIG. 4A. Thereafter, a first gate insulation film 24a in the MOS transistor of the memory cell part (first element region) was formed with SiO₂ film by thermal oxidation so as to have a thickness of 100-300 Å, and a second gate insulation film 24b in the MOS transistor of the peripheral circuit part (second element region) was also formed with SiO₂ film by thermal oxidation so as to have a thickness of 100-500 Å in another process. When the first gate insulation film 24a and the second gate insulation film 24b are formed in the same thickness, the oxide films may be formed simultaneously in the same process.

In order to form the MOS transistor having a n-depression type channel in the memory cell part (the left and central views in FIG. 4A), the peripheral circuit part (the right view in FIG. 4A) was masked with a resist film 26 for the purpose of controlling threshold voltage. To the region for forming a channel region just under the floating gate electrode, phosphor (P) or arsenic (As) was introduced as n-type impurity in a dose of 1×10¹¹-1×10¹⁴ cm⁻² by ion implantation to form a first threshold control layer 25a. The dose and conductive type of the impurity can be properly selected depending on selection of depression type or accumulation type.

In order to form the MOS transistor having a n-depression type channel in the peripheral circuit part (the right view of FIG. 4B), the memory cell part (the left and central views in FIG. 4B) was masked with a resist film 27 for the purpose of controlling the threshold voltage. To the region for forming a channel region just under the gate electrode, phosphor (P) or arsenic (As) was introduced as n-type impurity in a dose of 1×10¹¹-1×10¹⁴ cm⁻² by ion implantation to form a second threshold control layer 25b.

A first polysilicon film (first conductor film) 28 500-2000 Å thick was formed on the whole surface as the floating gate electrode of the MOS transistor of the memory cell part (the left and central views in FIG. 4C) and the gate electrode of the MOS transistor of the peripheral circuit part (the right view in FIG. 4C).

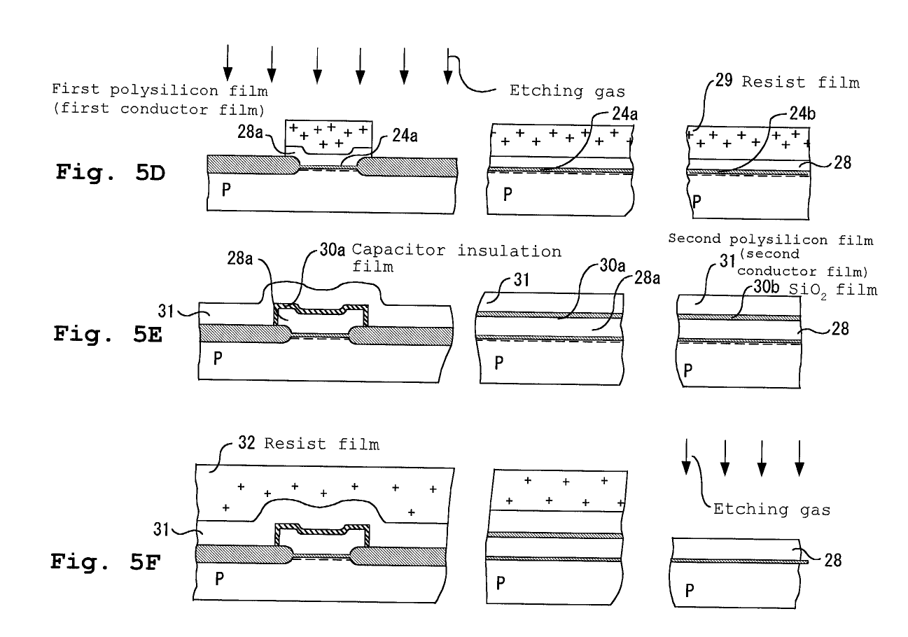

The first polysilicon film 28 was patterned with a resist film 29 formed as a mask, as shown in FIG. 5D, to form a floating gate electrode 28a in the MOS transistor of the memory cell part (the left and central views in FIG. 5D). At this time, the patterning was performed in X-direction so as to have a final dimension width, as shown in FIG. 5D, but not in Y-direction to leave the region for forming a S/D region layer as covered with the resist film 29.

After the resist film 29 was removed as shown in the left and central views in FIG. 5E, a capacitor insulation film 30a comprising SiO₂ film was formed in a thickness of about 200-500 Å by thermal oxidation so as to cover the floating gate electrode 28a. At this time, a capacitor insulating film 30b comprising SiO₂ film is also formed on the first polysilicon film 28 of the peripheral circuit part (the right view in FIG. 5E). The capacitor insulation films 30a and 30b, which were formed of only SiO₂ films herein, may be formed of a composite film comprising SiO₂ film and Si₃N₄ film laminated in 2-3 layers.

A second polysilicon film (second conductor film) 31 forming a control gate electrode was formed in a thickness of 500-2000 Å, as shown in FIG. 5E, so as to cover the floating gate electrode 28a and the capacitor insulation film 30a.

The memory cell part (the left and central views in FIG. 5F) was masked with a resist film 32 as shown in FIG. 5F, and the second polysilicon film 31 and capacitor insulation film 30b of the peripheral circuit part (the right view in FIG. 5F) were successively removed by etching to expose the first polysilicon film 28.

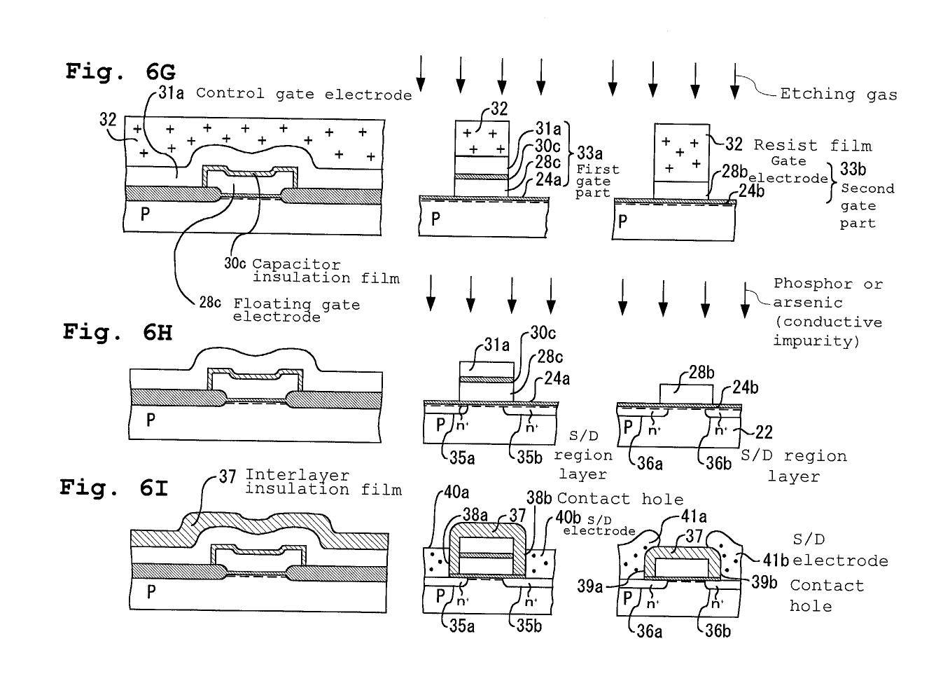

The second polysilicon film 31, capacitor insulation film 30a and first polysilicon film 28a patterned only in X-direction of the memory cell part (the left and central views in FIG. 6G) were patterned in Y-direction with the resist film 32 as a mask so as to have the final dimension of a first gate part 33a as shown in FIG. 6G, whereby a lamination by a control gate electrode 31a/a capacitor insulation film 30c/a floating gate electrode 28c about 1 μm in width was formed in Y-direction. The first polysilicon film 28 of the peripheral circuit part (the right view in FIG. 6G) was also patterned with the resist film 32 as a mask so as to have the final dimension of a second gate part 33b, whereby a gate electrode 28b about 1 μm in width was formed.

By use of the lamination by the control gate electrode 31a/the capacitor insulation film 30c/the floating gate electrode 28c of the memory cell part (the left and central views in FIG. 6H) as mask, phosphor (P) or arsenic (As) was introduced to the Si substrate 22 in the element forming region in a dose of 1×10¹⁴-1×10¹⁶ cm⁻² by ion plantation to form n-type S/D region layers 35a and 35b. Further, by use of the gate electrode 28b of the peripheral circuit part (the right view in FIG. 6H) as mask, phosphor (P) or arsenic (As) was introduced as n-type impurity in a dose of 1×10¹⁴-1×10¹⁶ cm⁻² to the Si substrate 22 in the element forming region to form S/D region layers 36a and 36b.

An underlayer insulation film 37 by PSG film was formed in a thickness of about 5000 Å so as to cover the first gate part 33a of the memory cell part (the left and central views in FIG. 61) and the second gate part 33b of the peripheral circuit part (the right view in FIG. 61).

Thereafter, contact holes 38a and 38b and contact holes 39a and 39b were formed in the underlayer insulating film 37 formed on the S/D region layers 35a and 35b and the S/D region layers 36a and 36b, and S/D electrodes 40a and 40b and S/D electrodes 41a and 41b were then formed.

According to the above, a FLASH EPROM was manufactured as semiconductor device as shown in FIG. 6I.

In this FLASH EPROM, since the second gate insulating film 24b of the peripheral circuit part (the right views in FIGS. 4A through 5F) are always covered with the first polysilicon film 28 or gate electrode 28b after the formation (the right views in FIGS. 4C-5F), the second gate insulating film 24b keeps the originally formed thickness. Therefore, the thickness control of the second gate insulating film 24b can be facilitated, and the adjustment of conductive impurity concentration for the control of threshold voltage can be also facilitated.

In the above example, the patterning for the formation of the first gate part 33a is performed with a prescribed width first in the gate lateral direction (X-direction in FIG. 3A) and then in the gate longitudinal direction (Y-direction in FIG. 3A) to form a final prescribed width, but the patterning may be reversely performed with the prescribed width first in the gate longitudinal direction (Y-direction in FIG. 3A) and then in the gate lateral direction (X-direction in FIG. 3A) to form the final prescribed width.

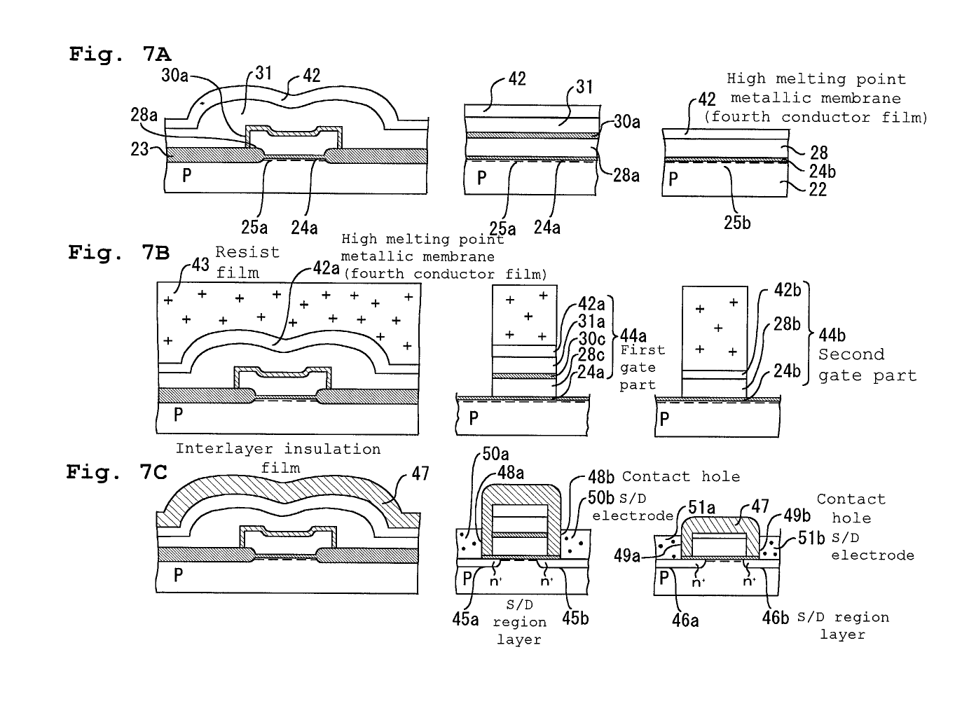

The example of manufacture of FLASH EPROM shown in FIGS. 7A through 7C is the same as the above example except changing the following process after the process shown in FIG. 5F in the above embodiment as shown in FIGS. 7A through 7C. Namely, the different point from the above example is that a high melting point metallic membrane (fourth conductor film) 42 comprising tungsten (W) film or titanium (Ti) film was formed in a thickness of about 2000 Å on the second polysilicon film 31 of the memory cell part (the left and central views in FIG. 7A) and the first polysilicon film 28 of the peripheral circuit part (the right view in FIG. 7A) to provide a polycide film. The processes after FIG. 7A or the processes shown in FIGS. 7B through 7C were performed in the same manner as in FIGS. 6G through 61. The description for the same process as FIGS. 6G through 61 was omitted, and the same part as in FIGS. 6G through 61 was shown by the same reference mark in FIGS. 7A through 7C.

According to the above, a FLASH EPROM was manufactured as semiconductor device as shown in FIG. 7C.

In this FLASH EPROM, since the high melting point metallic membranes (fourth conductor films) 42a and 42b are provided on the control gate electrode 31a and the gate electrode 28b, the electric resistance can be further reduced.

As the high melting point metallic membrane (fourth conductor film), a high melting point metal silicide membrane such as titanium silicide (TiSi) membrane, etc. may be used in addition to the above-mentioned high melting point metallic membranes (fourth conductor films) 42a and 42b.

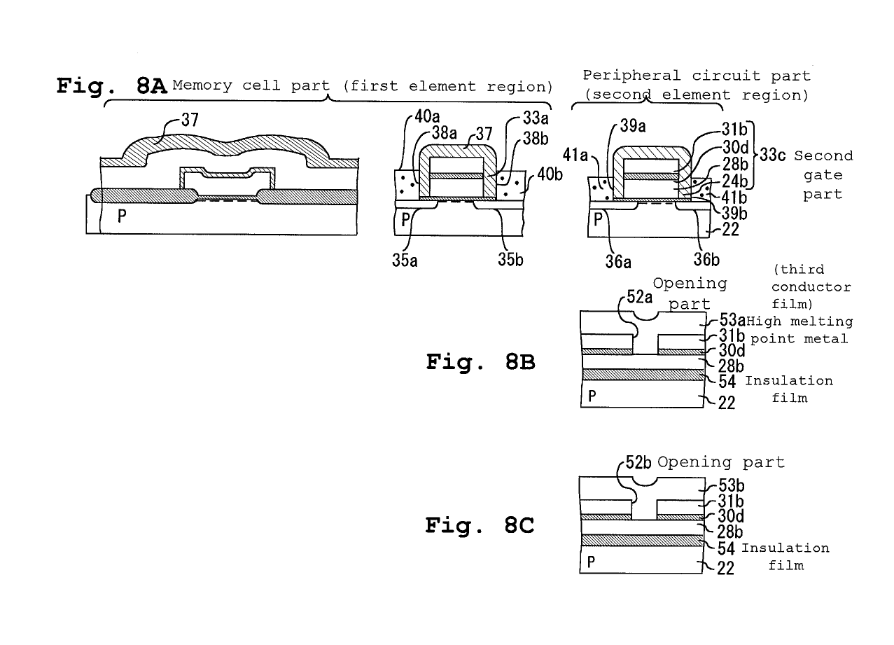

The example of manufacture of FLASH EPROM shown in FIGS. 8A through C is the same as the above example except constituting the second gate part 33c of the peripheral circuit part (second element region) (the right view in FIG. 8A) to have a structure comprising a first polysilicon film 28b (first conductor film)/a SiO₂ film 30d (capacitor insulation film)/a second polysilicon film 31b (second conductor film) similarly to the first gate part 33a of the memory cell part (first element region) (the left and central views in FIG. 8A), and short-circuiting the first polysilicon film 28b and the second polysilicon film 31b to form a gate electrode as shown in FIG. 8B or 8C.

As shown in FIG. 8B, an opening part 52a extending through the first polysilicon film 28b (first conductor film)/the SiO₂ film 30d (capacitor insulation film)/the second polysilicon film 31b (the second conductor film) is formed, for example, in a position different from the second gate part 33c shown in FIG. 8A, e.g., on an insulation film 54, and a third conductor film, for example, a high melting point metallic membrane 53a such as W film, Ti film, etc. is buried in the opening part 52a, whereby the first polysilicon film 28b and the second polysilicon film 31b are short-circuited. As shown in FIG. 8C, an opening part 52b extending through the first polysilicon film 28b (first conductor film)/the SiO₂ film 30d (capacitor insulation film) is formed to expose the first polysilicon film 28b of the lower layer to the bottom of the opening part 52b, and a third conductor film, for example, a high melting point metallic membrane 53b such as W film, Ti film, etc. is buried in the opening part 52b, whereby the first polysilicon film 28b and the second polysilicon film 31b are short-circuited.

In this FLASH EPROM, since the second gate part 33c of the peripheral circuit part has the same structure as the first gate part 33a of the memory cell part, the peripheral circuit part can be formed simultaneously with the formation of the memory cell part to effectively simplify the manufacturing process.

The third conductor film 53a or 53b and the high melting point metallic membrane (fourth conductor film) 42 may be simultaneously formed as a common high melting point metallic membrane in addition to the above independent formation.

### Example 3

Manufacture of Magnetic Head

Example 3 relates the manufacture of a magnetic head as an applied example of the resist pattern according to the present invention using the resist pattern thickening material according to the present invention. In Example 3, resist patterns 102 and 126 are thickened by the same method as in Example 1 by use of the resist pattern thickening material according to the present invention.

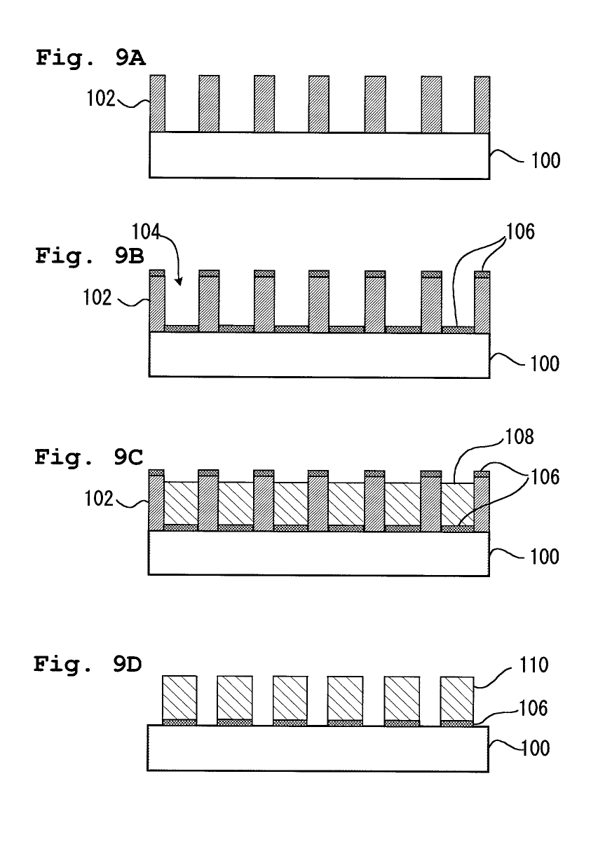

FIGS. 9A through D are flowcharts for showing the manufacture of the magnetic head.

A resist film was formed on an underlayer insulation layer 100 in a thickness of 6 μm, as shown in FIG. 9A, followed by exposure and development to form a resist pattern 102 having an opening pattern for forming a spiral thin film magnetic coil.

A plating underlying layer 106 comprising the lamination of a Ti adhesion layer 0.01 μm thick and a Cu adhesion layer 0.05 μm thick was formed by evaporation, as shown in FIG. 9B, on the resist pattern 102 and the part having no resist pattern 102 formed thereon or the exposed surface of the opening part 104 on the underlayer insulation layer 100.

A thin film conductor 108 comprising a Cu plating film 3 μm thick was formed, as shown in FIG. 9C, in the part having no resist pattern 102 formed thereon, or on the surface of the plating underlying layer 106 formed on the exposed surface of the opening part 104 on the underlayer insulation layer 100.

When the resist pattern 102 is dissolved and removed and lifted off from the underlayer insulation layer 100 as shown in FIG. 9D, a thin film magnetic coil 110 by the spiral pattern of the thin film conductor 108 is formed.

According to the above, the magnetic head was manufactured.

In the resulting magnetic head, since a spiral pattern is finely formed by the resist pattern 102 thickened by use of the thickening material according to the present invention, the thin film magnetic coil 110 is fine and fine, and also excellent in mass-productivity.

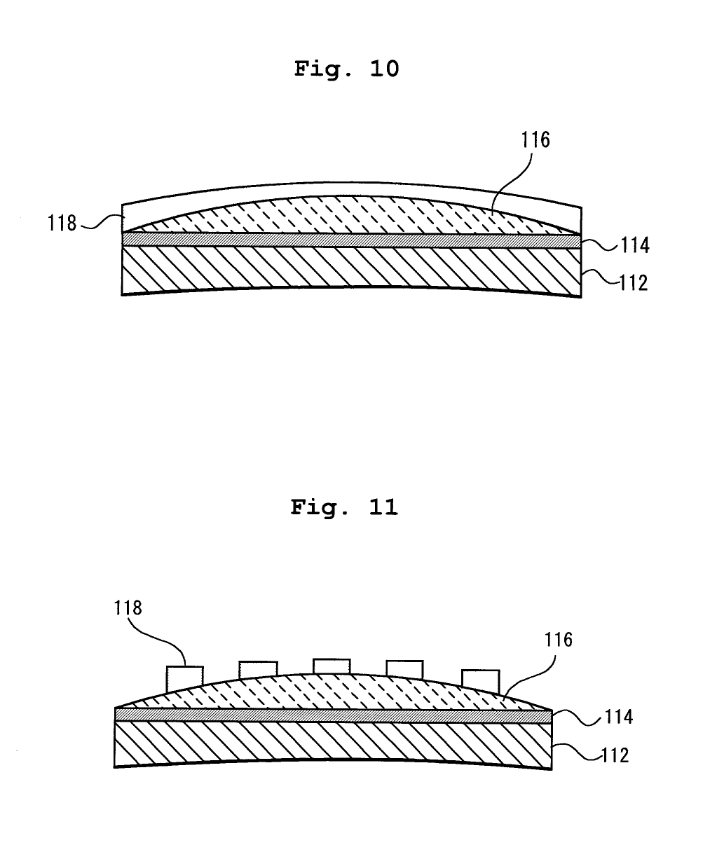

FIGS. 10 through 15 are flowcharts for showing the manufacture of another magnetic head.

A gap layer 114 was formed on a ceramic nonmagnetic substrate 112 by sputtering as shown in FIG. 10. An insulator layer by silicon oxide and a conductive underlying layer comprising Ni—Fe perm alloy, which are not shown, are preliminarily formed on the nonmagnetic substrate 112 by sputtering, and a lower magnetic layer comprising Ni—Fe perm alloy is further formed thereon. A resin insulation film 116 was formed by use of a thermosetting resin in a prescribed region on the gap layer 114 except the part forming the magnetic tip of the lower magnetic layer not shown. A resist material was then applied to the resin insulation film 116 to form a resist film 118.

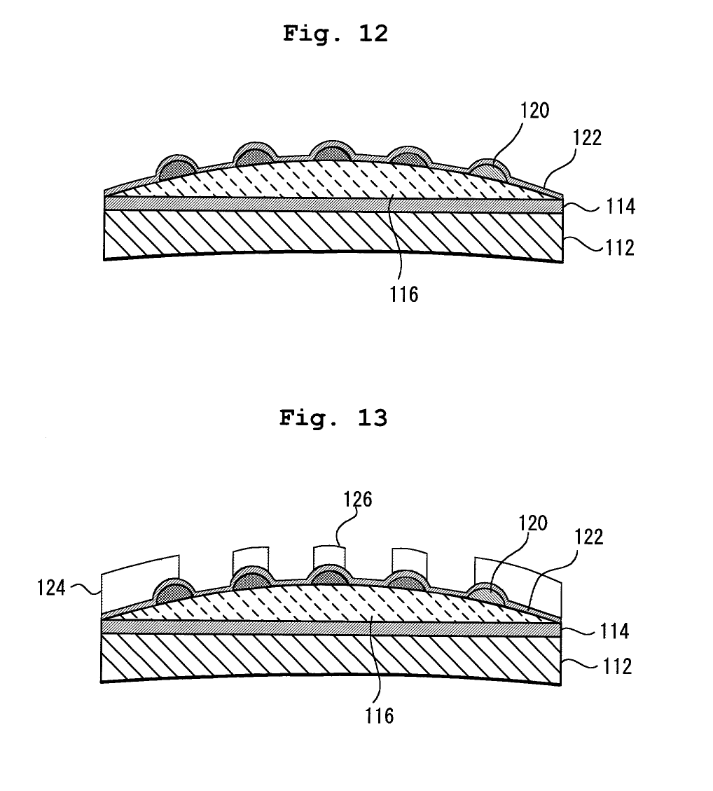

The resist film 118 was then subjected to exposure and development, as shown in FIG. 11, to form a spiral pattern. The resist film 118 of the spiral pattern was thermally set at several hundreds ° C. for about 1 hr as shown in FIG. 12 to form a projection-like first spiral pattern 120. A conductive underlying layer 122 comprising Cu was further formed on the surface thereof so as to cover it.

A resist material was applied onto the conductive underlying layer 122 by spin coating to form a resist film 124, as shown in FIG. 13, and the resist film 124 was patterned on the first spiral pattern 120 to form a resist pattern 126.

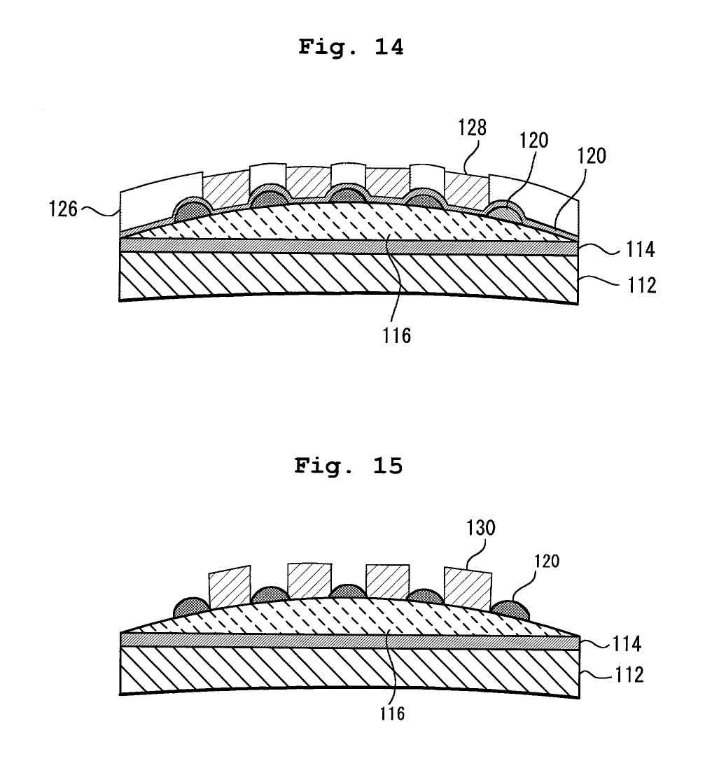

A Cu conductor layer 128 is formed by plating, as shown in FIG. 14, on the exposed surface of the conductive underlying layer 122, or on the part having no resist pattern 126 formed thereon. Thereafter, the resist pattern 126 was lifted off, as shown in FIG. 15, from the conductive underlying layer 122 by being dissolved and removed to form a spiral thin film magnetic coil 130 by the Cu conductor layer 128.

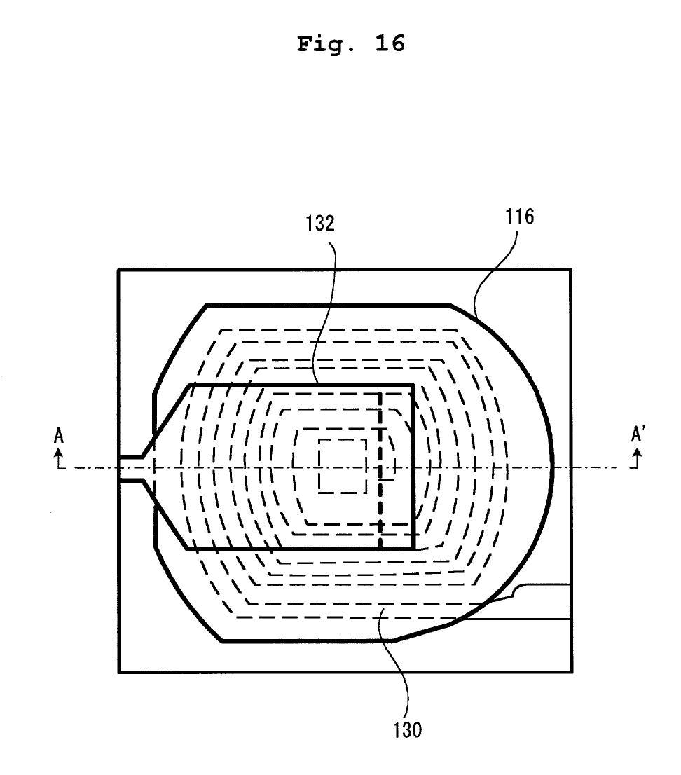

According to the above, a magnetic head having the magnetic layer 132 on the resin insulation film 116 and the thin film magnetic coil 130 on the surface, as shown in the plan view of FIG. 16, was manufactured.

In the resulting magnetic head, since a spiral pattern is finely formed by the resist pattern 126 thickened by use of the thickening material according to the present invention formed thereon, the thin film magnetic coil 130 is fine and fine, and also excellent in mass-productivity.

According to the present invention, a resist pattern having an upperlayer excellent in etching resistance on an underlayer resist pattern usable of not only KrF excimer laser but also ArF excimer laser in patterning and capable of forming a fine pattern can be provided.

Further, according to the present invention, a method for forming a resist pattern usable of light as exposure light, excellent in mass-productivity and capable of manufacturing a fine pattern by resist pattern finely exceeding the exposure limit of light can be provided.

According to the present invention, a resist pattern thickening material suitably usable for the forming of a fine pattern by resist pattern to efficiently thicken an underlayer resist pattern and also capable of imparting etching resistance to the surface thereof can be also provided.

Additionally, according to the present invention, a high performance semiconductor device having a fine pattern by resist pattern can be provided.

Further, according to the present invention, a method for manufacturing a semiconductor device usable of light as exposure light and capable of efficiently mass-producing a semiconductor device having a fine pattern by resist pattern formed finely exceeding the exposure limit of light can be provided.

What is claimed is:

1. A resist pattern thickening material comprising;
a resin;
a crosslinking agent; and
a water-soluble aromatic compound.

2. A resist pattern thickening material according to claim 1 wherein the water-soluble aromatic compound exhibits a water-solubility of 1 g or more to 100 g of 25° C. water.

3. A resist pattern thickening material according to claim 1, wherein the water-soluble aromatic compound has at least two polar groups.

4. A resist pattern thickening material according to claim 3, wherein the polar groups are selected from hydroxyl group, carboxyl group and carbonyl group.

5. A resist pattern thickening material according to claim 1, wherein the water-soluble aromatic compound is at least one type selected from a polyphenol compound, an aromatic carboxylic acid compound, a perhydroxy naphthalene polyhydric alcohol compound, a benzophenone compound, a flavonoid compound, and derivatives and glycosides thereof.

6. A resist pattern thickening material according to claim 1, wherein the resin is at least one type selected from polyvinyl alcohol, polyvinyl acetal, and polyvinyl acetate.

7. A resist pattern thickening material according to claim 1, wherein the resin contains 5-40% by mass (by mol) of the polyvinyl acetal.

8. A resist pattern thickening material according to claim 1, wherein the crosslinking agent is at least one type selected from a melamine derivative, a urea derivative and a uril derivative.

9. A resist pattern thickening material according to claim 1, further comprising a surfactant.

10. A resist pattern thickening material according to claim 9, wherein the surfactant is at least one type selected from a polyoxyethylene-polyoxypropylene condensed compound, a polyoxyalkylene alkyl ether compound, a polyoxyethylene alkyl ether compound, a polyoxyethylene derivative compound, a sorbitan fatty acid ester compound, a glycerin fatty acid ester compound, a primary alcohol ethoxylate compound, and a phenol ethoxylate compound.

11. A resist pattern thickening material according to claim 1, further comprising an organic solvent.

12. A resist pattern thickening material according to claim 11, wherein the organic solvent is at least one type selected from an alcohol solvent, a chain ester solvent, a cyclic ester solvent, a ketone solvent, a chain ether solvent, and a cyclic ether solvent.

13. A resist pattern comprising an upperlayer provided on an underlayer resist pattern, with an etching rate (Å/s) ratio (underlayer resist pattern/upperlayer) of the underlayer resist pattern to the upperlayer under the same condition of 1.1 or more.

14. A resist pattern according to claim 13, wherein the upperlayer contains an aromatic compound, and the underlayer resist pattern contains a non-aromatic compound.

15. A resist pattern comprising an upperlayer containing an aromatic compound on an underlayer resist pattern containing no water-soluble aromatic compound.

16. A resist pattern according to claim 15, wherein a content of the aromatic compound is gradually reduced from the upperlayer to an inner part.

17. A resist pattern according to claim 15, wherein a surface of the resist pattern is applied with a resist pattern thickening material comprising;
a resin;
a crosslinking agent; and
a water-soluble aromatic compound; so as to cover the surface of the underlayer resist pattern after the formation of the underlayer resist pattern.

18. A resist pattern according to claim 15, wherein a material of the underlayer resist pattern is at least one type selected from an acrylate resist having an alicyclic functional group on a side chain, a cycloolefin-maleic anhydride resist and a cycloolefin resist.

19. A resist pattern according to claim 18, wherein the alicyclic functional group is selected from an adamantyl group and a norbornane group, and the cycloolefin resist contains at least one of norbornane and adamantane in a main chain thereof.

20. A method for forming a resist pattern comprising:
a step for applying a resist pattern thickening material so as to cover a surface of an underlayer resist pattern after formation of the underlayer resist pattern, wherein the resist pattern thickening material comprises;
a resin;
a crosslinking agent; and
a water-soluble aromatic compound.

21. A method for forming a resist pattern according to claim 20, wherein the material of the underlayer resist pattern is at least one type selected from an acrylate resist having an alicyclic functional group on the side chain, a cycloolefin-maleic anhydride resist and a cycloolefin resist.

22. A method for forming a resist pattern according to claim 21, wherein the alicyclic functional group is selected from an adamantyl group and a norbornane group, and the cycloolefin resist contains at least one of norbornane and adamantane in the main chain thereof.

23. A method for forming a resist pattern according to claim 20, wherein a development of the resist pattern thickening material is performed after applying the resist pattern thickening material.

24. A method for forming a resist pattern according to claim 23, wherein the development is performed by using deionized water.

25. A semiconductor device comprising a pattern formed by a resist pattern, wherein the resist pattern comprises an upperlayer containing an aromatic compound on an underlayer resist pattern containing no water-soluble aromatic compound.

26. A method for manufacturing a semiconductor device comprising:
a step for forming a resist pattern by applying a resist pattern thickening material to cover a surface of an underlayer resist pattern to thicken the underlayer resist pattern to form the resist pattern, after forming the underlayer resist pattern on an underlying layer,
a step for patterning the underlying layer by performing an etching using the resist pattern formed in the step for forming the resist pattern as a mask.

27. A method for manufacturing a semiconductor device according to claim 26, wherein the material of the underlayer resist pattern is at least one type selected from an acrylate resist having an alicyclic functional group on the side chain, a cycloolefin-maleic anhydride resist and a cycloolefin resist.

28. A method for manufacturing a semiconductor device according to claim 27, wherein the alicyclic functional group is selected from an adamantyl group and a norbornane group, and the cycloolefin resist contains at least one of norbornane and adamantane in the main chain.

29. A method for manufacturing a semiconductor device according to claim 26, further comprising:
a step for applying a nonionic surfactant to the surface of the underlayer resist pattern prior to the step for forming the resist pattern;
wherein the nonionic surfactant is at least one type selected from a polyoxyethylene-polyoxypropylene condensed compound, a polyoxyalkylene alkyl ether compound, a polyoxyethylene alkyl ether compound, a polyoxyethylene derivative compound, a sorbitan fatty acid ester compound, a glycerin fatty acid ester compound, a primary alcohol ethoxylate compound, and a phenol ethoxylate compound.

30. A method for manufacturing a semiconductor device according to claim 26, wherein a development of the resist pattern thickening material is performed after applying the resist pattern thickening material.

31. A method for manufacturing a semiconductor device according to claim 30, wherein the development is performed using deionized water.
